(19) United States
(12) Patent Application Publication
(10) Pub. No.: US 2007/0215833 A1
(43) Pub. Date: Sep. 20, 2007

(54) Strap actuated flapper valve

(75) Inventors: Robert H. Reinicke, Mission Viejo, CA (US); David J. Schroepfer, Trinidad, CO (US)

Correspondence Address: MCNEES WALLACE & NURICK LLC, 100 PINE STREET, P.O. BOX 1166, HARRISBURG, PA, 17108-1166, US

(73) Assignee: CIRCOR INTERNATIONAL, INC., Burlington, MA (US)

(21) Appl. No.: 11/378,039

(22) Filed: Mar. 17, 2006

(51) Int. Cl. F16K 1/18

(52) U.S. Cl. 251/294; 251/298

(57) ABSTRACT

A valve for controlling the flow of cryogenic fluid. The valve includes a valve body and a sealing member pivotably mounted within the valve body. The valve also includes an actuator mechanism that pivots the sealing member from a closed position to an open position to allow flow of fluid through the valve body. The sealing member provides a seal against a portion of said valve body to substantially prevent flow of fluid through the valve in the closed position. A linkage connects the sealing member and the actuator mechanism. The linkage is capable of translating the direction of a force from the actuator mechanism to a direction suitable for pivoting the sealing member toward either the open position or the closed position.

### FIELD OF THE INVENTION

The present invention is directed to a strap actuated valve system. In particular, the present invention is directed to a large pneumatically actuated valve for use in cryogenic, as well as non-cryogenic, rocket propellant fluid systems found in space launch vehicles, space stations and other spacecraft.

### BACKGROUND OF THE INVENTION

Space vehicle rocket propulsion systems often include a plurality of large (generally considered 2 inch line size and greater) valves. The valves stop, start and sometimes modulate the flow of liquid rocket propellants from storage tanks and to rocket engines. Propellants include cryogenic (liquefied gas) propellants, such as liquid oxygen and liquid hydrogen, and non-cryogenic liquid hydrocarbon propellants, such as kerosene. Propellant system valves must allow essentially unobstructed and straight-through fluid flow to minimize pressure drop, yet must be very compact and the lowest possible weight for efficient use in space vehicles. The valves are usually operated by pneumatic pressure (typically 750 psi helium gas), applied and vented through a 3-way solenoid pilot valve to an actuation piston to open and close the valve, although direct electromechanical (rotary or linear motor) operation is also possible. In the case of rotary valve closure elements, notably the ball and butterfly styles, a linkage system is incorporated to convert the axial motion and force of the pneumatic actuating piston to a turning motion and torque to rotate the flow control element open and closed. In addition to very low temperature (−280° F. to −453° F.) cryogenic propellants, such valves must operate under high pressure water-hammer surges and with the aerodynamic forces induced by high fluid flow rates. These demanding operating conditions require special design configuration and construction methods. For example, the valve structure must mitigate thermal shrinkage and distortion of the sealing surfaces, as well as accommodate the severe hardening of the valve plastic sealing materials at cryogenic temperatures, to prevent excessive leakage past the closure element. The plastic sealing surfaces of the valve closure elements (called valve seats) are susceptible to finish deterioration due to seal rubbing, wear and contamination abrasion during valve opening and closing cycles. This causes seat leakage to increase as valve operating cycles accumulate, often seriously limiting the useful cycle life of the valves.

Ball valves are often used in cryogenic propellant applications. Ball valves operate by rotating a bearing mounted ball closure element within a valve body. In the open position, a flow hole through the ball allows substantially straight and unobstructed fluid flow through the valve body. Ball valves exhibit very low pressure drop, but are bulky and heavy due to the inherently large ball closure element and the bulky pneumatic piston axial-to-rotary actuation drive system, usually a multi-bar linkage or rack and pinion. To effect valve closure, the ball is rotated until the hole no longer allows flow through the valve and the ball seals against a matching concave spherical plastic seating ring in the valve body. The plastic seat is designed to be fluid pressure-energized to reduce the mechanical friction between the seal and the ball during most of the rotation of the ball, then uses the buildup of line pressure differential in the valve closed position to energize and force the seat against the ball with more force. Nevertheless, the seal still rubs against the rotating ball, causing any particulate contamination to scratch the plastic seat (in the direction of leakage), thereby increasing the seat leakage as more operating cycles accumulate. The edge of the flow hole through the ball rubs and distorts against the seat during ball rotation, further aggravating the seat wear and deterioration of the plastic seating material.

Another type of valve sometimes used in cryogenic propellant applications is the butterfly valve. Butterfly valves use a circular disc closure element that has a bearing mounted pivot axis transverse to the direction of flow in the valve body. When the disc is rotated closed, it engages and seals against a spherical plastic seat in the valve body. Butterfly valves are more compact and lighter than the ball type, but the close tolerance plastic seal is very difficult and expensive to manufacture and use a bulky actuation drive system. Also, the butterfly disc partially obstructs flow in the open position which causes higher pressure drop. The cryogenic temperature hardened plastic seat rubs and distorts as it engages and leaves the butterfly disc, introducing high friction forces, and causing wear and particulate contamination to scratch the plastic seat (in the direction of leakage), thereby increasing the seat leakage as more operating cycles occur.

Another type of valve that could be, but is seldom, used in cryogenic propellant application is the gate valve. Gate valves are linear motion (vs. the rotary motion of ball and butterfly valves) having a flat closure element that slides across the flow stream of the valve body to shut-off fluid flow. Gate valves use a flat seat, which should reduce cost compared to the spherical seats found in ball and butterfly valves. However, gate valves suffer from the major drawback that the pressure differential loading on the gate is difficult to carry in a low friction manner since linear ball bearing guides are difficult and expensive to implement. The seat, although of the preferred flat configuration, still rubs during opening and closing, thus sharing the leakage, contamination and life-limiting wear deficiencies of the ball and butterfly types. Also, the flow path is partially obstructed with the linkage needed to move the gate.

What is needed is an pneumatic actuated cryogenic valve that uses an inexpensive, compact, low weight no-rubbing flat seat closure element and actuator drive system, and that allows straight through and unobstructed fluid flow.

### SUMMARY OF THE INVENTION

The present invention includes a valve for controlling the flow of cryogenic fluid. The valve includes a valve body and a closure element pivotably mounted within the valve body. The valve also includes an actuator mechanism that pivots the closure element from a closed position to an open position to allow flow of fluid through the valve body. The sealing member provides a seal against a portion of said valve body to substantially prevent flow of fluid through the valve in the closed position. A linkage connects the closure element to the pneumatic actuator piston. The linkage is capable of translating the axial direction of a force from the actuator piston to a turning direction suitable for pivoting the sealing member toward either the open position or the closed position.

The present invention also includes a valve for a space launch vehicle. The valve includes a valve body fluidly connected to a cryogenic propellant system of a space launch vehicle and a sealing member pivotably mounted within the valve body. The valve also includes an actuator mechanism that pivots the sealing member from a closed position to an open position to allow flow of fluid through the valve body. The sealing member provides a seal against a portion of said valve body to substantially prevent flow of fluid through the valve in the closed position. A flexible linkage connects the pneumatic piston to the closure element. The linkage is capable of translating the axial direction of a force from the pneumatic piston to a rotary direction suitable for pivoting the closure element.

An advantage of the valve according to the present invention is that the valve incorporates non-rubbing seat, eliminating friction and greatly mitigating seat wear and contamination damage, thereby minimizing leakage and providing longer valve cycle life. The seat can be a simple and inexpensive non-pressure-energized design since the pressure differential buildup in the closed position forces the closure element against the seat with considerable sealing force.

Another advantage of the valve according to the present invention is that the valve uses a lightweight flexible linkage mechanism that is compact and positionable substantially transverse to the flow path, allowing the valve to be installed with reduced profile and weight.

Another advantage of the valve according to the present invention is that the valve provides a reliable failsafe position. The failsafe position is maintained by both a tensioning device, such as a spring, and a force from fluid present in the valve body.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 shows a perspective view of a valve according to one embodiment of the present invention.

FIG. 2 schematically illustrates a cutaway view of a valve according to an embodiment of the present invention in a closed position.

FIG. 3 schematically illustrates a cutaway view of a valve according to an embodiment of the present invention in an open position.

FIG. 4 shows a perspective view of a closure element according to an embodiment of the present invention.

### DETAILED DESCRIPTION OF THE INVENTION

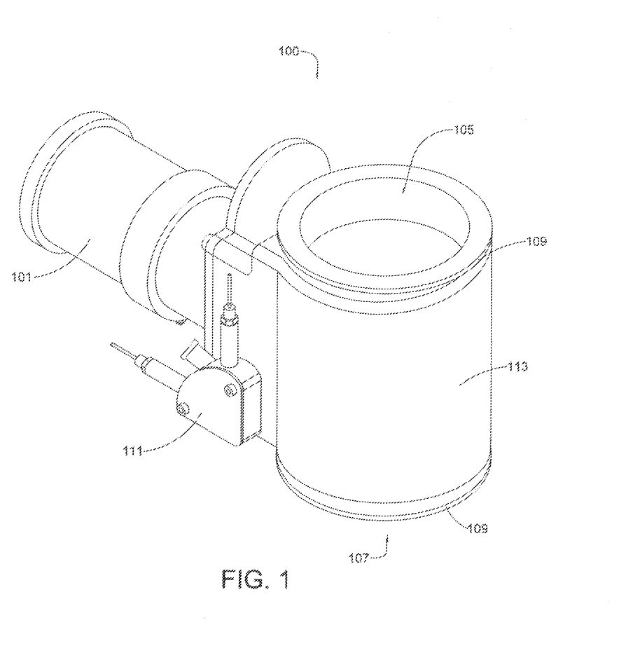

FIG. 1 shows a perspective view of a valve 100 according to the present invention. The valve 100 includes an actuator mechanism 101 attached to a valve body 103. The valve body 103 includes an inlet end 105 and an outlet end 107. The inlet end 105 and the outlet end 107 preferably have a flange 109 to permit the installation of the valve into a fluid containing system, such as a liquefied fuel system for a space launch vehicle. Although FIG. 1 depicts a flange 109, any attachment mechanism known in the art may be used to install the valve into the fluid system. FIG. 1 further shows an optional valve position indicator 111, which communicates the position of the valve 100 to a user or control system. The valve body 103 is preferably fabricated from high strength aluminum or titanium alloy to minimize weight.

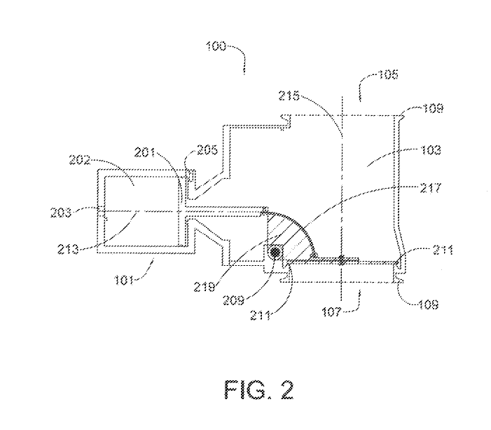

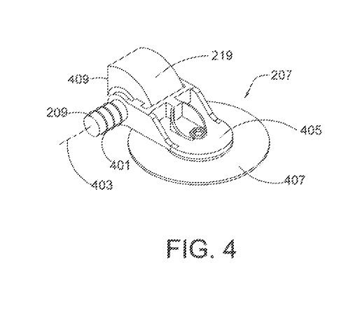

FIG. 2 schematically illustrates a cutaway view of a valve 100 according to the present invention in a closed position. The valve 100 includes actuator mechanism 101 attached to valve body 103, as shown in FIG. 1. In addition, the valve body 103 includes inlet end 105, outlet end 107 and opposed flanges 109, as shown in FIG. 1. The actuator mechanism 101 includes an actuator piston 201, an actuator chamber 202, a first actuating fluid opening 203 and a second actuating fluid opening 205. The first and second actuating fluid openings 203 and 205 provide an access through which a fluid, such as helium, may pass. A sealing member 207 is pivotably attached to the valve body 103 by a pivot rod 209. A tensioning device 401 (see FIG. 4) is arranged and disposed to provide a rotational tensioning force for urging sealing member 207 to pivot the sealing member 207 against a seat 211 found in the valve body 103. In a preferred embodiment, the tensioning device 401 is a helical torsion spring mounted on the pivot rod 209. The rotational force provided by the tensioning device 401 and any pressure differential that exists is sufficient to seat the sealing member 207 against seat 211 and substantially prevent leakage of fluid through the valve body 103 past outlet end 107. Preferably, no leakage of fluid through the valve body 103 is permitted in the closed position. In a preferred embodiment, the tensioning device 401 supplies sufficient rotational force to pivot the sealing member 207 about pivot rod 209 to substantially prevent flow of fluid through the valve without the addition of external force, such as from the actuator mechanism 101. A strap 217 that is connected to both the piston 201 and sealing member 207 is preferably fabricated from a pliable material able to withstand cryogenic temperatures and sufficiently strong to pivot the sealing member 207 about pivot rod 209 under fluid pressure. A suitable strap material is titanium alloy of about 0.015 inch thick and 1.5 inch wide which provides both the bending strength, tensile strength, and flexibility needed to operate a 4-inch valve (line) size.

Although the above tensioning device 401 is preferably a helical torsion spring, any device that provides tensioning for pivoting the sealing member 207 to a closed position may be used, such as a helical compressions spring or cantilever beam type spring. Alternatively, valve 100 may utilize no tensioning device and allow the fluid flow to provide a force upon the sealing member 207 to initiate closure and to secure the sealing member 207 against seat 211.

The actuator mechanism 101 shown in FIG. 2 is oriented such that an actuator chamber center axis 213 is substantially perpendicular or transverse to a valve body center axis 215. The perpendicular or transverse positioning of the actuator mechanism 101 permits the height of the valve, i.e., the distance between opposed flanges 109, to be minimized. A strap 217 is fastened to the shaft of the actuator piston 201 and to the sealing member 207. A drum portion 219 is attached to the sealing member 207 and forms a geometry that conforms the strap 217 into a curved geometry. As shown in FIG. 2, when the sealing member 207 is in the closed position, the strap 217 along the surface of the drum portion 219. Although FIG. 2 shows the drum portion 219 as being a semicircular geometry, the drum may be formed with any geometry that provides support for the strap 217 and is capable of translating a force provided by the actuator piston 201 in a direction substantially parallel to the actuator chamber center axis 213 to a force on the sealing member 207 in a direction substantially parallel to the valve body center axis 215. Although a strap 217 has been shown and described as a linkage between the actuator piston 201 and the sealing member 207, any linkage capable of translating the directional force of the actuator mechanism 101 to pivot the sealing member 207 may be used.

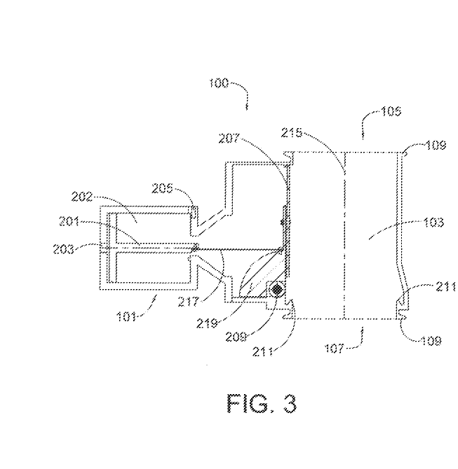

FIG. 3 schematically illustrates a cutaway view of valve 100 according to the present invention in an open position. FIG. 3 shows the valve 100, including the elements shown and described with respect to FIG. 2. The actuator mechanism 101 and the sealing member 207 may be positioned such that the flow of fluid from inlet end 105 to outlet end 107 is substantially without obstruction and change of direction, permitting the flow to pass with a minimal pressure drop. In FIG. 3, the actuator mechanism 101 has been activated by pressurization of port 205 with helium gas or another suitable fluid providing actuator piston 201 a force in a direction substantially parallel to the actuator chamber center axis 213 to a force on the sealing member 207 in a direction substantially parallel to the valve body center axis 215 sufficient to pivot the sealing member 207 about pivot rod 209. As the sealing member pivots about pivot rod 209, the direction of its force applied to the sealing member 207, which is substantially transverse to the surface of the sealing member, changes from being substantially parallel to valve body center axis 215 in the closed position to being substantially parallel to the actuator chamber axis 213 in the open position by the actuator piston 201.

The actuator mechanism 101 operates by admitting actuating fluid via the second actuating fluid opening 205 into an actuator chamber 202. As fluid fills chamber 202, a fluid force is provided to the actuator piston 201 which urges the piston to move in a direction toward the first actuating fluid opening 203. Fluid present in the chamber 202 between the actuator piston 201 and the first actuating fluid opening 203 is permitted to exit the actuator chamber 202 through first actuating fluid opening 203. The actuator mechanism 101 may be operating in any suitable manner to achieve the desired flow of actuating fluid into and out of the actuator chamber 202 through the first and second actuating fluid openings 203 and 205. The actuating fluid may any fluid capable of filling chamber 202 and moving the actuator piston 201 with force sufficient to pivot sealing member 207. In space launch vehicles, a lightweight substantially inert fluid is preferred, such as helium which remains in a gaseous state at cryogenic propellant temperatures. The actuator mechanism 101 may position the sealing member 207 in any position from fully open to fully closed. Once the sealing member 207 pivots from the closed position, fluid is permitted to flow through the valve body 103 between inlet end 105 and outlet end 107. In a preferred embodiment, the actuator pivots the sealing member 207 into a fully open position (see FIG. 3) or a fully closed position (see FIG. 2).

The movement of the actuator piston 201 rotates the sealing member 207 in the opening direction by a force translated by the strap 217. The strap 217 straightens as the sealing member 207 rotates about pivot rod 209. As the strap 217 straightens, the force acting on the sealing member 207 rotates from the valve body center axis 215 in a direction toward the actuator chamber center axis 213. In the embodiment shown in FIG. 3, when the sealing member 207 is in the fully open position, the strap 217 is substantially linear and the force provided by the actuator piston 201 and the strap 217 are substantially parallel.

While FIGS. 2 and 3 arrange the actuator with the actuator chamber center axis 213 substantially perpendicular to the valve body center axis 215, any orientation of actuator may be used that allows the translation of force through the strap sufficient to position the sealing member 207 in an open position.

In addition, while FIGS. 1-3 illustrate a pneumatic actuator mechanism, the actuator may utilize any suitable force producing mechanism, including, but not limited to, an electromagnetic actuator or linear motor.

FIG. 4 shows a perspective view of a sealing member 207 according to the present invention shown without the valve body 103 or actuator mechanism 101. The sealing member 207 is pivotably attached to the valve body 103 by pivot rod 209 and pivots about a pivot rod center axis 403 (see FIGS. 2 and 3). Pivot rod 209 also includes tensioning device 401, shown as a torsion helical spring, that is arranged to provide a rotational force about the pivot rod center axis 403 in a direction that pivots the sealing member 207 to a closed position. The sealing member 207 includes a support portion 405, a sealing portion 407 and a drum portion 219. The support portion 405 is detachably connected to the sealing portion 407. The support portion is fabricated of titanium alloy or another high strength and lightweight metal alloy. The sealing portion 407 provides a substantially fluid tight seal against the seat 211 of the valve body 103 (see FIG. 2) to substantially prevent the flow of fluid through the valve body 103. The sealing portion is fabricated of titanium alloy or another high strength and lightweight metal alloy with a plastic, such as Teflon, insert at the sealing perimeter to the body seat (211). The separate support portion 405 and sealing portion 407 arrangement permits the sealing portion to self-align onto the body seat (211). In addition, the separate components permit the sealing member 207 to replace easily without the need to remove the sealing member 207 or disassemble the valve 100. The drum portion 219 supports strap 217, permitting strap 217 to translate the force from the actuator piston 201 to a force that rotates the sealing member 207 to an open position. The drum portion 219 further includes a stop surface 409 that abuts the valve body 103, establishing the fully open position of the sealing member 207 when the actuator is activated.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A valve for controlling the flow of cryogenic fluid comprising:
a valve body;
a sealing member pivotably mounted within the valve body;
an actuator mechanism arranged and disposed to pivot the sealing member from a closed position to an open position to allow flow of fluid through the valve body, the sealing member providing a seal against a portion of said valve body to substantially prevent flow of fluid through the valve in the closed position; and
a linkage connecting the sealing member and the actuator mechanism, the linkage being capable of translating the direction of a force from the actuator mechanism to a direction suitable for pivoting the sealing member toward one of an open position and a closed position.

2. The valve of claim 1, wherein the linkage is a strap.

3. The valve of claim 2, wherein the valve body includes a drum portion, the drum portion comprising a surface that supports the strap when the strap is translating the direction of force.

4. The valve of claim 3, wherein the drum portion includes a stop surface that engages a surface of the valve body when the actuator pivots the sealing member into a fully open position.

5. The valve of claim 1, wherein the sealing member includes a tension providing device providing a rotational force that pivots the sealing member to a closed position when no additional force is provided by the actuator mechanism.

6. The valve of claim 1, wherein the actuator mechanism is a fluid driven piston actuator.

7. The valve of claim 1, wherein the actuator mechanism is an electromagnetic actuated mechanism.

8. The valve of claim 1, wherein the valve body further includes a recessed portion to receive the seal member when the seal member is in the open position and to provide a substantially unobstructed flow path for fluid through the valve body.

9. The valve of claim 1, the valve further comprising a position indicator attached to the valve body and the sealing member and indicating the position of the sealing member.

10. A valve for a space launch vehicle comprising:
a valve body fluidly connected to a liquefied fuel system of a space launch vehicle;
a sealing member pivotably mounted within the valve body;
an actuator mechanism arranged and disposed to pivot the sealing member from a closed position to an open position to allow flow of fluid through the valve body, the sealing member providing a seal against a portion of said valve body to substantially prevent flow of fluid through the valve in the closed position; and
a linkage connecting the sealing member and the actuator mechanism, the linkage being capable of translating the direction of a force from the actuator mechanism to a direction suitable for pivoting the sealing member toward one of an open position and a closed position.

11. The valve of claim 10, wherein the linkage is a strap.

12. The valve of claim 11, wherein the valve body includes a drum portion, the drum portion comprising a surface that supports the strap when the strap is translating the direction of force.

13. The valve of claim 12, wherein the drum portion includes a stop surface that engages a surface of the valve body when the actuator pivots the sealing member into a fully open position.

14. The valve of claim 10, wherein the sealing member includes a tension providing device providing a rotational force that pivots the sealing member to a closed position when no additional force is provided by the actuator mechanism.

15. The valve of claim 10, wherein the actuator mechanism is a fluid driven piston actuator.

16. The valve of claim 10, wherein the actuator mechanism is an electromagnetic actuated mechanism.

17. The valve of claim 10, wherein the valve body further includes a recessed portion to receive the seal member when the seal member is in the open position and to provide a substantially unobstructed flow path for fluid through the valve body.

18. The valve of claim 10, the valve further comprising a position indicator attached to the valve body and the sealing member and indicating the position of the valve.

19. The valve of claim 10, wherein the liquefied fuel system is at a cryogenic temperature.
